(19) United States
(12) Patent Application Publication
(10) Pub. No.: US 2025/0284283 A1
(43) Pub. Date: Sep. 11, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: YOHEI SHIRAKI, Tokyo (JP); MASAKAZU FUJIKI, Kanagawa (JP); AKITERU NAKA, Tokyo (JP)

(21) Appl. No.: 19/069,497

(22) Filed: Mar. 4, 2025

(30) Foreign Application Priority Data
Mar. 5, 2024 (JP) 2024-032940

(51) Int. Cl. G05D 1/246; G01C 21/20; G05D 1/648; G05D 101/00; G05D 105/10

(52) U.S. Cl. CPC G05D 1/246; G01C 21/206; G05D 1/6484; G05D 2101/22; G05D 2105/10

(57) ABSTRACT

In an information processing apparatus, a work setting information acquisition unit configured to acquire a type of work performed by a movable apparatus, information with respect to a work region, and map information for self-position estimation created in advance, and a starting position and orientation calculation unit configured to calculate a starting position and orientation when the work is started based on the type of the work, the work region, and the map information are provided.

### BACKGROUND OF THE INVENTION

### Field of the Invention

The present invention relates to an information processing apparatus, an information processing method, a storage medium, and the like.

### Description of the Related Art

Autonomous movable apparatuses that estimate self-position and orientation based on data acquired from various sensors and autonomously travel to realize predetermined work, such as automated guided vehicles used in factories and warehouses or autonomous moving floor cleaning robots used in commercial facilities, are commonly used.

When the autonomous movable apparatus performs work such as cleaning and conveyance, an entry prohibited region may be designated in addition to a work region. In such a case, a method for determining the starting point of work based on a relation between a work region and a traveling prohibited region of the autonomous movable apparatus is proposed in Japanese Patent Application Laid-Open No. 2023-501831.

However, in the method in Japanese Patent Application Laid-Open No. 2023-501831, there is a case in which the self-position estimation for estimating which position and orientation on the map the current position and orientation are at the time of starting the self-position estimation fails, and the work cannot be started.

### SUMMARY OF THE INVENTION

An information processing apparatus according to one aspect of the present invention comprises a work setting information acquisition unit configured to acquire a type of work performed by a movable apparatus, information with respect to a work region, and map information for self-position estimation created in advance, and a starting position and orientation calculation unit configured to calculate a starting position and orientation when the work is started based on the type of the work, the work region, and the map information.

Further features of the present invention will become apparent from the following description of embodiments with reference to the attached drawings.

### BRIEF DESCRIPTION OF THE DRAWINGS

FIG. 1 is a usage scene image diagram of a movable apparatus 200 mounted with an information processing apparatus according to the first embodiment of the present invention.

FIG. 2 is a diagram illustrating an example of a hardware configuration of an information processing apparatus 100 according to the first embodiment.

FIG. 3 is a functional block diagram illustrating a logical configuration example of the information processing apparatus 100 according to the first embodiment and the movable apparatus 200 mounted with the information processing apparatus 100.

FIG. 4 is a flowchart showing a processing example of an information processing method using an information processing apparatus according to the first embodiment.

FIG. 5 is a flowchart illustrating an example of processes of determining a starting position and orientation in the information processing method according to the first embodiment.

FIG. 6 is a flowchart illustrating a detailed example of step S203 of determining a starting position and orientation in the first embodiment.

FIG. 7 is a diagram showing an example of an occupancy grid map created by a LiDAR in the fourth embodiment.

FIG. 8 is a flowchart explaining in detail a processing example of starting position and orientation determination (step S203) in the fourth embodiment.

FIG. 9 a diagram showing an example of an operation screen in the fifth embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

In the first embodiment, an autonomous moving floor cleaning robot (a movable apparatus) that automatically performs floor surface cleaning in a commercial facility and the like will be explained as a movable apparatus according to the embodiment. However, the movable apparatus according to the embodiment may be a robot that performs other work, or may be a vehicle, a drone, and the like that performs automatic driving or driving assistance.

In the present embodiment, the target to be estimated in the self-position estimation of the movable apparatus is position and orientation in real space of a reference coordinate system that is fixed to the movable apparatus. The movable apparatus estimates the position and orientation of the sensor based on information acquired from a sensor and calculates the position and orientation of the movable apparatus based on the relation between the reference coordinate system and the attached position and orientation of the sensor. Note that in the following embodiments, “position and orientation” refers to both position and orientation combined.

In the first embodiment, at the starting time of the work performed by the autonomous movable apparatus, a candidate having a high possibility of success in global self-position estimation and close to the movement starting point of the cleaning work is preferentially selected from a position and orientation candidate group, and the selected position and orientation is set as the starting position and orientation. As a result, the possibility that work can be started while reducing unnecessary movement other than the work can be increased.

The movable apparatus described in the first embodiment creates a self-position estimation map in advance using Simultaneous Localization And Mapping (SLAM). Note that SLAM is a technology in which a sensor, such as a distance sensor and a stereo camera, is disposed on a movable apparatus, and the position and orientation of the sensor and a map of the surrounding environment are estimated.

At the work execution time of floor cleaning and the like, self-position estimation is performed based on a map created using SLAM (hereinafter referred to as a “SLAM map”) and a sensor value of the sensor mounted on the autonomous movable apparatus.

In the first embodiment, the movable apparatus has a stereo camera mounted in the traveling direction, for example. Additionally, for example, an information processing apparatus that is mounted on a movable apparatus detects feature points from images that have been acquired from left and right lenses of the stereo camera, estimates the three-dimensional position and orientation of the stereo camera by performing three-dimensional geometric measurement by stereo matching, and calculates the position and orientation of the movable apparatus.

Note that the SLAM map using the stereo camera includes information on a plurality of spatially discrete positions and orientations, image data captured at each position and orientation, image coordinate information of a feature point cloud that has been detected from each image data by the AKAZE algorithm, image feature information, and the like. Note that AKAZE is an abbreviation for “Accelerated KAZE Features”.

Here, a key frame refers to a set of image data, the position and orientation of a movable apparatus at the time of capturing the image data, image coordinate information of feature points that have been detected from the image data, image feature information, and three-dimensional position and orientation information of feature points and the like that have been calculated by stereo vision. Thus, the map information includes the point group feature information based on the point cloud data that has been acquired from the distance measuring sensor including a stereo camera.

In order to perform work such as floor cleaning, the movable apparatus according to the first embodiment first extracts an image feature from a current camera image by the AKAZE algorithm when self-position estimation with reference to the SLAM map starts. Then, a key frame having a scene similar to the extracted image feature is searched from the SLAM map by using a bag of words (BoW) algorithm.

The current position and orientation in the map coordinate system is estimated by referring to the position and orientation of the key frame having a similar scene searched from the map. Then, the result of self-position estimation is updated by calculating the relative change in position and orientation with reference to the immediately preceding position and orientation each time the image frame of the stereo camera is updated.

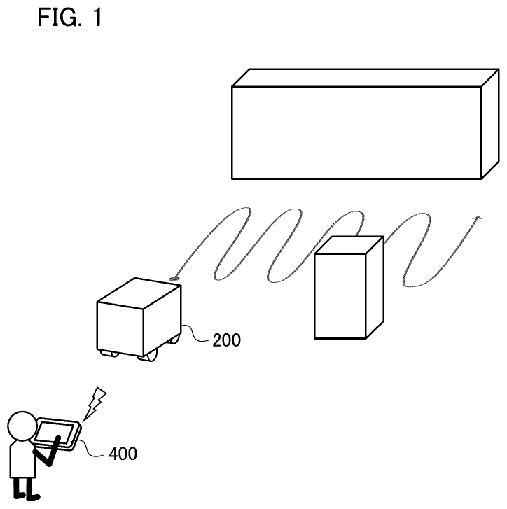

FIG. 1 is an image diagram of a usage scene of a movable apparatus 200 on which an information processing apparatus according to the first embodiment of the present invention is mounted. The management of the movable apparatus 200 and the content of the work performed by the movable apparatus 200 are set via a movable apparatus control terminal 400.

The work setting information set in the movable apparatus 200 when setting the work content includes a map name for identifying a map to be referred to when the movable apparatus 200 travels, type information for identifying a type of work, coordinate information according to the type of work, and information regarding a work region. Note that the coordinate information is information including at least one XY coordinate in a map coordinate system in which the movable apparatus 200 travels.

In this context, the type of work includes contents such as cleaning work using teaching playback and cleaning work by zigzag traveling. Additionally, the coordinate information in the cleaning work using the teaching playback is obtained by recording a plurality of XY coordinates and orientation θ in which the movable apparatus 200 travels in time series. Note that the coordinate information in the cleaning work using the zigzag traveling is obtained by recording XY coordinates of two vertices which are opposite angles when the work region is represented by a rectangle.

Hereinafter, information set in the movable apparatus 200 using the movable apparatus control terminal 400 is referred to as “work setting information”. The movable apparatus 200 autonomously moves in a work region set by a movable apparatus operator via the movable apparatus control terminal 400, and by driving the cleaning unit, performs cleaning work while autonomously traveling.

When the movable apparatus operator sets a travel path in the cleaning work of the movable apparatus 200, the movable apparatus operator displays the SLAM map stored in the movable apparatus 200 on the movable apparatus control terminal 400 and drags the pointing device so that the travel path becomes a desired travel path. In this manner, travel path teaching is performed.

The movable apparatus control terminal 400 displays, superimposed on the map, an icon image corresponding to the movable apparatus 200 indicating the starting position and orientation determined by the information processing apparatus 100 on the map. Accordingly, the movable apparatus operator can confirm the starting position and orientation of the movable apparatus 200 determined by the information processing apparatus 100.

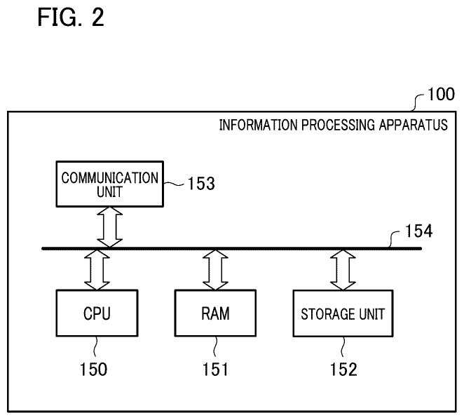

FIG. 2 is a diagram illustrating an example of a hardware configuration of the information processing apparatus 100 according to the first embodiment. The information processing apparatus 100 is configured by a CPU 150, a RAM 151, a storage unit 152 including an HDD and an SSD, a communication unit 153, a system bus 154, and the like.

The CPU 150 uses the RAM 151 as a work memory, executes an operating system (OS) and various computer programs stored in the storage unit 152, and controls each unit via the system bus 154. The computer programs executed by the CPU 150 include a computer program for proposing, and the like, a work start position of the movable apparatus 200.

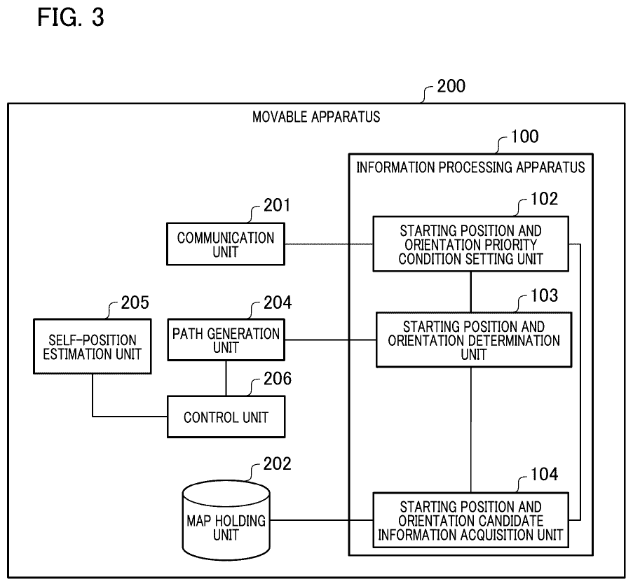

FIG. 3 is a functional block diagram illustrating a logical configuration example of the information processing apparatus 100 according to the first embodiment and the movable apparatus 200 on which the information processing apparatus 100 is mounted. Note that some of the functional blocks as shown in FIG. 3 are realized by causing the CPU and the like that serve as a computer included in the movable apparatus and the information processing apparatus 100 to execute a computer program stored in a memory that serves as a storage medium.

However, some or all of these functional blocks may be realized by hardware. For the hardware, a dedicated circuit (ASIC), a processor (reconfigurable processor, DSP), and the like can be used. In addition, each functional block as shown in FIG. 3 need not be incorporated in the same housing and may be configured by separate devices that are connected to each other via a signal path.

In the first embodiment, the movable apparatus 200 is configured by an information processing apparatus 100, a communication unit 201, a map holding unit 202, a path generation unit 204, a self-position estimation unit 205, a control unit 206, and the like. However, some of the functional blocks as shown in FIG. 3 (for example, the information processing apparatus 100) may be provided in a server that is provided outside the movable apparatus, in the movable apparatus control terminal 400, and the like.

The information processing apparatus 100 is configured by a starting position and orientation priority condition setting unit 102, a starting position and orientation determination unit 103, a starting position and orientation candidate information acquisition unit 104, and the like, and determines the starting position and orientation of the movable apparatus 200.

The communication unit 201 receives work setting information from the movable apparatus control terminal 400 by wireless communication and notifies the work setting information to the starting position and orientation priority condition setting unit 102 of the information processing apparatus 100. The information processing apparatus 100 starts a process of determining a starting position and orientation, which is a position and orientation at self-position estimation activation start time when starting the work of the movable apparatus 200, and the like, based on the work setting information from the movable apparatus operator input via the communication unit 201.

The map holding unit 202 stores a SLAM map necessary for the movable apparatus 200 to estimate a self-position. The path generation unit 204 generates a travel path of the movable apparatus 200 based on an input from the movable apparatus operator and the starting position and orientation that has been determined by the information processing apparatus 100.

The control unit 206, which has a CPU incorporated therein, estimates the self-position of the movable apparatus 200 with the self-position estimation unit 205, and controls various actuators based on the self-position estimation result of the self-position estimation unit 205 in order to travel along the path generated by the path generation unit 204.

The starting position and orientation priority condition setting unit 102 sets which position and orientation is to be preferentially selected when determining the starting position and orientation. That is, the starting position and orientation priority condition setting unit 102 sets a priority for each of a plurality of starting position and orientation candidates. The starting position and orientation candidate information acquisition unit 104 acquires a starting position and orientation that serves as a starting position and orientation candidate and information related thereto.

The starting position and orientation determination unit 103 determines the starting position and orientation when the work is started based on the information acquired by the starting position and orientation candidate information acquisition unit 104 and the priority that has been set by the starting position and orientation priority condition setting unit 102. Then, the determined starting position and orientation is transmitted to the path generation unit 204 and transmitted (notified) to the movable apparatus control terminal 400.

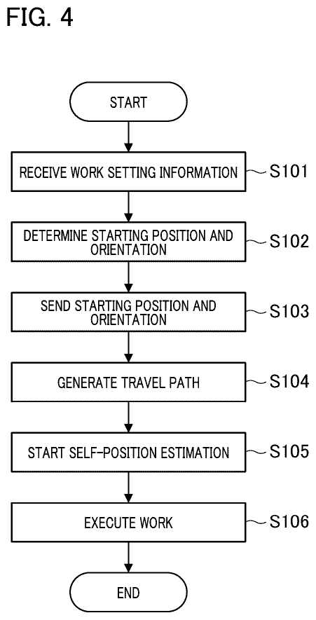

Here, a flow of processes will be explained with reference to FIG. 4 to FIG. 6. First, FIG. 4 is a flowchart illustrating a processing example of an information processing method using the information processing apparatus according to the first embodiment. Note that the operations of each step in the flowcharts shown in FIG. 4 to FIG. 6 are sequentially performed by the CPU and the like that serve as the computer within the information processing apparatus 100 or the control unit 206 executing a computer program stored in memory.

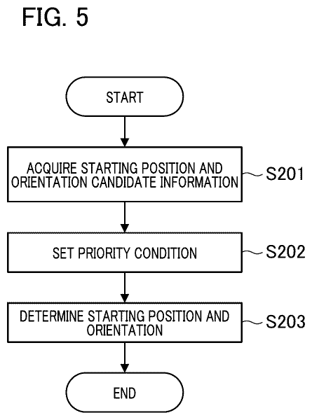

In FIG. 4, a sequence of the entire system of the movable apparatus 200 when cleaning work is designated will be explained. Next, in FIG. 5, a detailed flow of the starting position and orientation determination will be explained. FIG. 4 illustrates processes when the movable apparatus operator sets work such as cleaning, the information processing apparatus 100 calculates the starting position and orientation candidate information, and the movable apparatus 200 starts execution of the work.

The movable apparatus 200 waits until work setting information is input by the movable apparatus operator via the communication unit 201, and starts subsequent processes when, in step S101, work setting information including work type and the like is received.

It is assumed that the SLAM map to be used has been created in advance by the movable apparatus operator using the movable apparatus 200, and the type of work is a cleaning operation recorded using the teaching playback method. Note that, in this context, the work setting information includes at least information with respect to a type of work and a work region performed by the movable apparatus, and map information for self-position estimation created in advance.

Additionally, step S101 functions as a work setting information acquisition step (work setting information acquisition unit) of acquiring information with respect to a type of work and a work region performed by the movable apparatus and map information for self-position estimation created in advance.

Upon receiving the work setting information, in step S102, the information processing apparatus 100 calculates and determines the starting position and orientation. Here, step S102 functions as a starting position and orientation calculation step (starting position and orientation calculation unit) of calculating the starting position and orientation when the work is started based on the type of work, the work region, and the map information.

When the information processing apparatus 100 calculates the starting position and orientation, in step S103, the movable apparatus 200 transmits the starting position and orientation to the movable apparatus control terminal 400 of the movable apparatus operator and the path generation unit 204 via the communication unit 201.

Next, in step S104, the path generation unit 204 generates a path for performing a predetermined operation based on the starting position and orientation that has been determined by the information processing apparatus 100. Next, in step S105, upon receiving a starting command from the communication unit 201, the movable apparatus 200 starts the self-position estimation unit 205 and starts self-position estimation.

Finally, in step S106, the control unit 206 controls an actuator (for example, a motor) of the movable apparatus 200 based on the travel path generated by the path generation unit 204 and the position and orientation estimated by the self-position estimation unit 205. Thus, for example, a mop for cleaning and the like are rotated to start cleaning work.

Note that in a case in which the starting position and orientation of the work are predefined, such as in the teaching playback method, the travel path from the starting position and orientation to the work starting position and orientation is generated in the travel path generation processing in step S104. Then, after moving to the work start position, the movable apparatus starts the playback operation based on the teaching content starts.

FIG. 5 is a flowchart showing an example of a process of determining the starting position and orientation in the information processing method according to the first embodiment and shows details of step S102 in FIG. 4. When the information processing apparatus 100 receives the work setting information set by the movable apparatus operator using the movable apparatus control terminal 400, the information processing apparatus 100 starts processing for determining the starting position and orientation as shown in FIG. 5.

First, in step S201, the starting position and orientation candidate information acquisition unit 104 projects the three-dimensional position and orientation of key frames included in the SLAM map to be used onto two-dimensional position and orientation, wherein the two-dimensional position and orientation are the position on the XY plane on which the movable apparatus 200 travels and the orientation θ of the movable apparatus 200. Then, the two-dimensional position and orientation obtained by the projection is acquired as the starting position and orientation candidate information.

Note that in the following embodiments, it is assumed that the position of the movable apparatus 200 is coordinates on an XY plane on which the movable apparatus 200 travels in the map coordinate system, and that the orientation of the movable apparatus 200 is the orientation θ indicating the traveling direction of the movable apparatus 200 in the map coordinate system. Note that the X-axis direction of the map coordinate system is defined as θ=0.

In step S202, the starting position and orientation priority condition setting unit 102 sets a priority condition based on the work setting information (for example, a work type and the like) set by the movable apparatus operator and received via the communication unit 201. That is, in step S202, the priority is set based on the type of work, and the like.

Note that the work type in the first embodiment is a cleaning operation recorded using the teaching playback method, and the XY coordinates and the orientation θ of the movable apparatus 200 in the map coordinate system are recorded in the cleaning operation data in chronological order according to the path along which the movable apparatus 200 travels.

In the first embodiment, priority conditions are set so that start position and orientation candidate information having a position closer to the work start position and orientation and having smaller differences in orientation is given higher priority. Note that the work start position and orientation is the position and orientation that is recorded first in the above cleaning operation data.

In step S203, the starting position and orientation determination unit 103 determines the starting position and orientation based on the above priority condition, the image information included in the key frame corresponding to each of the starting position and orientation candidates that have been acquired by the starting position and orientation candidate information acquisition unit 104, and the like.

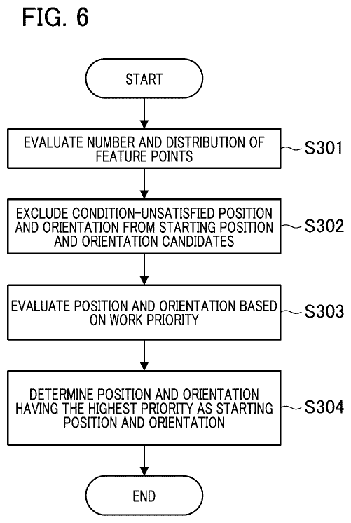

FIG. 6 is a flowchart illustrating a detailed example of step S203 of determining the starting position and orientation in the first embodiment.

In step S301 of FIG. 6, the starting position and orientation determination unit 103 evaluates the starting position and orientation candidates acquired in step S201 from the viewpoint of the success probability of global self-position estimation.

At this time, the evaluation is performed based on the number and distribution of feature points included in the key frame used for calculation of each of the starting position and orientation candidates. That is, the evaluation is performed based on the number and distribution of feature points included in the key frame corresponding to each of the starting position and orientation candidates. Note that here, it is determined that the success probability of the global position estimation is higher as the number of detected feature points becomes larger and the detection locations are distributed more widely in the image coordinate system.

Specifically, in step S301, a number of image features included in a camera image of the key frame is counted, the camera image is divided into, for example, 6×8 grids, and the number of grids including feature points is counted and recorded in association with the starting position and orientation candidates. The same processing is performed on all the candidates for the starting position and orientation.

In step S302, the starting position and orientation determination unit 103 determines, from the starting position and orientation candidates, a position and orientation in which the number of recorded feature points is, for example, less than 30 or the number of grids including the recorded feature points is, for example, 20 or less, as the condition-unsatisfied position and orientation. Then, condition-unsatisfied position and orientations are excluded from the starting position and orientation candidates.

Next, in step S303, the position and orientation are evaluated based on the work priority. That is, the starting position and orientation determination unit 103 evaluates the priority of the starting position and orientation candidates based on the condition that has been set by the starting position and orientation priority condition setting unit 102, and calculates an evaluation value p. This evaluation is performed on the starting position and orientation candidates that have not been excluded in step S302.

Here, the above evaluation value p related to priority is calculated by, for example, Formula 1 below. The value p indicates that priority is higher as the value becomes smaller. Here, the first term on the right-hand side represents evaluation of the position, and the second term represents evaluation of the orientation. x and y are coordinates on the XY plane on which the movable apparatus moves, and x0 and y0 are start coordinates of the work on the XY plane.

The angdiff function is a function that takes two orientation angles as arguments and returns the angle difference between these angles. Additionally, θ denotes the orientation of the movable apparatus, and θ0 denotes the orientation of the movable apparatus at the work start time. Note that k1 and k2 denote weight coefficients.

$$p = {k}_{1} \sqrt{{( x - {x}_{0} )}^{2} + {( y - {y}_{0} )}^{2}} + {k}_{2} angdiff ( θ , {θ}_{0} ) \qquad ( FORMULA 1 )$$

In step S304, the starting position and orientation determination unit 103 determines, from among starting position and orientation candidates for which priorities have been respectively calculated, the position and orientation having the highest priority (That is, having the smallest evaluation value p) as the starting position and orientation.

As described above, according to the first embodiment, it is possible to determine a starting position and orientation that can achieve both the constraints of the work or passage and the success of global self-position estimation at the start of self-position estimation, such as when the work is started.

### Modification 1-1

Note that in the first embodiment, the camera image is divided into 6×8 grids to evaluate the distribution of the feature points. Additionally, although the position and orientation corresponding to the key frame in which the number of feature points is equal to or less than 30 or the number of grids including the feature points is equal to or less than 20 is deleted from the starting position and orientation candidates, and any values may be used without limitation to these values.

### Modification 1-2

Additionally, in the above-described embodiment, although the cleaning of the filled region and the cleaning of the designated region using the teaching playback have been described, region designation is not limited thereto. For example, separately from the work region, a region to be designated as the starting position and orientation by the movable apparatus operator may be set via the movable apparatus control terminal 400. Alternatively, a method of designating only a movement start point and a movement end point in an autonomous moving transfer robot and the like may be adopted.

### Modification 1-3

Additionally, in the above-described embodiment, the position and orientation corresponding to the key frame in which the number of feature points is 30 or less or the number of grids including the feature points is 20 or less is deleted from the starting position and orientation candidates, and thereafter the position and orientation having the smallest evaluation value p related to the priority is determined as the starting position and orientation.

However, a total evaluation value e may be calculated based on the number, distribution, and priority of feature points by, for example, Formula 2 below, and the starting position and orientation may be determined based on the total evaluation value e. Here, Pf denotes the number of feature points detected at the detected position and orientation, and Pg denotes the number of grids including the feature points. Additionally, k3, k4, and k5 denote weight coefficients.

$$e = {k}_{3} {P}_{f} + {k}_{4} {P}_{g} - {k}_{s} p \qquad ( FORMULA 2 )$$

### Modification 1-4

In the first embodiment, in step S201, when the starting position and orientation candidate information is acquired, the position and orientation information of key frames stored in the SLAM map is used. However, candidate information of starting position and orientation may be acquired by another method if the position and orientation in which success probability of self-position estimation can be calculated, and work priority can be calculated.

That is, in Modification 1-4, the method of evaluating the number and distribution of feature points differs between the starting position and orientation candidate information acquisition in step S201 and the starting position and orientation determination in step S203 (step S301).

When acquiring candidate information of starting position and orientation in step S201, the entire region of the SLAM map is divided into grids of a predetermined size. Position and orientation that combines the center coordinates of each grid and orientations respectively rotated by predetermined angles at each center coordinate are set as candidates for starting position and orientation.

Next, an evaluation method of the number and distribution of feature points in step S301 of the modification 1-4 will be explained. From the SLAM map, feature points are extracted that are within a predetermined distance in a position and orientation that becomes a starting position and orientation candidate and that fall within a camera angle of view in a case in which an image is captured in the position and orientation that becomes a starting position and orientation candidate.

The extracted feature points are then projected onto an image plane based on the focal length and resolution of the camera. The number of feature points projected on the image plane and the number of grids including the feature points counted by dividing the image plane into grids of a predetermined size, are recorded in association with a candidate for target starting position and orientation. The same processing is performed on all the candidates for the starting position and orientation. Subsequently, the starting position and orientation is determined by performing processing similar to step S302 and subsequent steps.

As described above, according to the first embodiment, it is possible to determine the starting position and orientation suitable for starting from a wider region regardless of the path traveled during storage of the map. Additionally, it is possible to realize an information processing apparatus capable of calculating starting position and orientation according to the type of work.

### Second Embodiment

In the first embodiment, the starting position and orientation priority condition setting unit 102 determined that positions and orientations are more suitable for global self-position estimation as the number of feature points included in the key frame becomes larger and the region in which the feature points are distributed becomes wider.

However, the method of setting initial position and orientation priority condition is not limited thereto. In the second embodiment, an example in which the priority is determined focusing on the ease of self-position estimation when the priority condition of the starting position and orientation priority condition setting unit 102 in step S202 is set will be explained.

For example, the appearance of architectural structures such as ceilings and columns generally does not fluctuate with date or time. In contrast, the arrangement of items such as a chair and a cardboard box can change frequently, even daily. Therefore, if feature points are detected on a chair or cardboard box before they are moved, and the chair or cardboard box is subsequently relocated, the previously detected feature points cannot be used, making them unsuitable for determining the start position and orientation.

Accordingly, in the second embodiment, the start position and orientation priority condition setting unit 102 sets conditions such that higher priority is assigned to positions and orientations at which architectural structures with unchanging arrangement, such as ceilings and columns, are more frequently observed. At this time, the starting position and orientation determination unit 103 applies semantic segmentation to an image included in the key frame corresponding to each of the starting position and orientation candidates and detects a wall and a ceiling.

Then, feature points are detected on the image regions of the detected wall and ceiling, and evaluation is performed such that priority becomes higher as the number of the feature points becomes larger and the region in which these feature points are distributed becomes wider. Note that the starting position and orientation priority condition setting unit 102 may identify a movable or moving object, for example, a door and a curtain, through object recognition, and may set a condition such that the position and orientation obtained from an image including these objects is evaluated as unsuitable for the startup position and orientation.

That is, the starting position and orientation determination unit 103 performs object recognition on an image included in the key frame associated with each of the starting position and orientation candidates, and recognizes a movable or moving object, for example a door and a curtain. The area of image including the recognized object is calculated, and the evaluation is performed such that the priority becomes lower as the calculated area becomes larger.

Additionally, the starting position and orientation priority condition setting unit 102 may set a condition such that the priority of an environment in which the position and orientation is likely to be erroneously recognized becomes lower. For example, image features detected in areas such as a checkered pattern, a large lattice window, and a fully tiled wall are similar and are prone to misrecognition of self-position. A condition may be set such that such an environment is not suitable as the starting position and orientation.

That is, the starting position and orientation determination unit 103 detects a periodic structure using a machine learning algorithm and frequency analysis for an image included in the key frame associated with each of the starting position and orientation candidates. The area of the image region of the detected periodic structure is calculated, and the evaluation is performed such that the priority becomes lower as the calculated area becomes larger.

According to the second embodiment as described above, the starting position and orientation that is suitable for starting can be determined at a location at which the movable apparatus is placed.

### Third Embodiment

In the first embodiment, the starting position and orientation priority condition setting unit 102 determined that positions and orientations are more suitable for global self-estimation as the number of feature points included in the key frame becomes larger and the region in which the feature points are distributed becomes wider.

However, the method of setting initial position and orientation priority condition is not limited thereto. In the third embodiment, in step S202, when setting priority conditions in step S202, the starting position and orientation priority condition setting unit 102 determines priority with focus on whether or not positions and orientations are appropriate as work start position and orientation. That is, priority is set based on the shape (circular, square, and the like), location (position of center of gravity, and the like), movement pattern (zigzag pattern, spiral pattern, and the like), and the like of the work region.

In the operation setting of the work, methods are considered in which cleaning work is performed by zigzag travel or by spiral pattern travel in a work region designated by the movable apparatus operator through the movable apparatus control terminal 400. In this case, in the third embodiment, travel may start from the outer periphery of the work region.

In this case, the starting position and orientation priority condition setting unit 102 sets conditions such that priority of regions closer to the outer periphery of the work region is increased. For this purpose, the starting position and orientation determination unit 103 calculates, for example, a distance between the position of the starting position and orientation candidate and the outer periphery of the work region and performs the evaluation such that the priority becomes higher as the distance becomes shorter.

In contrast, in the operation setting for the work, in a case in which the cleaning operation is performed by traveling in a spiral pattern from the work center toward the outer perimeter in a work region designated by the movable apparatus operator on the movable apparatus control terminal 400, travel starts from near the center of the work region. In this case, the starting position and orientation priority condition setting unit 102 may set a condition such that the priority of a region close to the centroid of the work region is increased.

In this case, the starting position and orientation determination unit 103 calculates coordinates of the position of the center of gravity of the work region. Then, the distance between the position of the starting position and orientation candidate and the position of the center of gravity of the work region is calculated, and evaluation is performed such that the priority becomes higher as the distance becomes shorter. Note that the work region may be approximated by a quadrilateral or an ellipse, and the center of the quadrilateral or the ellipse may be set as the position of the center of gravity.

Alternatively, in the operation setting of the work, there is a case in which the movable apparatus operator designates the work content and directly designates the desired position of the starting position and orientation by using the movable apparatus control terminal 400. In this case, the movable apparatus 200, after being activated at the starting position and orientation desired by the movable apparatus operator, autonomously travels to the work region, and thereafter starts the work.

At this time, it is desirable that the starting position and orientation priority condition setting unit 102 sets conditions such that the priority is increased as the position and orientation becomes closer to the starting position and orientation desired by the movable apparatus operator that has been set via the movable apparatus control terminal 400. That is, priority may be set based on the starting position and orientation of the movable apparatus.

Alternatively, the starting position and orientation priority condition setting unit 102 may set priority conditions such that priority of starting position and orientation becomes higher when total travel distance or required time from start to work completion becomes minimized.

In that case, the start position and orientation determination unit 103 evaluates each starting position and orientation among starting position and orientation candidates generated by the path generation unit 204, so that the priority becomes higher for paths with the shortest travel distance or shortest travel time to work completion.

### Fourth Embodiment

In the first embodiment, the starting position and orientation was determined based on distribution of image features detected from camera images. In contrast, in the fourth embodiment, in a case in which self-position and orientation of the movable apparatus is estimated using shape information measured by a distance sensor as input, the starting position and orientation is determined based on distribution of objects in the work region space.

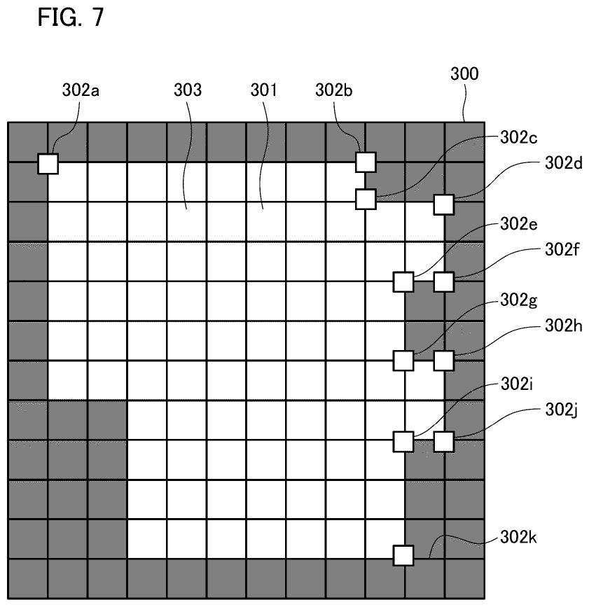

FIG. 7 is a diagram illustrating an example of an occupancy grid map created by the LiDAR in the fourth embodiment. That is, FIG. 7 is an occupancy grid map created by measuring a work region using, for example, 2D LiDAR (Light Detection and Ranging), acquiring position data of point clouds on the surfaces of surrounding objects, and using this position data.

In the grids of an occupancy grid map 300, cells filled in gray represent cells determined to be regions in which an object is present or unknown regions based on map generation using the 2D-LiDAR sensor and SLAM algorithm.

In contrast, it is assumed that a white cell (for example, 303) is a region in which no object is present, and in the fourth embodiment, it is assumed that either the entire region indicated by white cells or parts thereof is a cleaning region 301 designated by the movable apparatus operator. Additionally, points at which curvature of a curve that connects point clouds scanned by the 2D-LiDAR exceeds a threshold value and which can be detected as corners are corner points 302a to 302k.

Here, in a case in which the description is made without identifying which of the corner points 302a to 302k a point is, the point is simply referred to as the corner point 302.

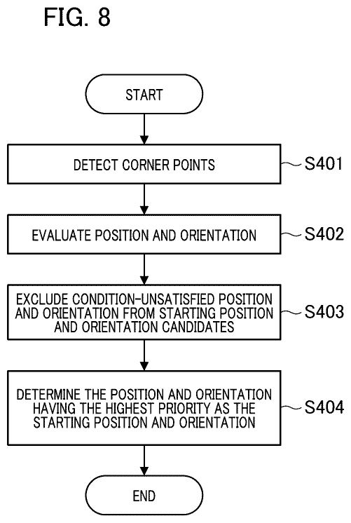

FIG. 8 is a flowchart explaining in detail a processing example of the starting position and orientation determination (step S203) in the fourth embodiment. Note that operations of each step in the flowcharts as shown in FIG. 8 are sequentially performed by the CPU and the like that serve as the computer within the information processing apparatus 100 executing a computer program stored in memory.

In step S401, the starting position and orientation determination unit 103 detects corner points from the occupancy grid map. Because the 2D LiDAR in the fourth embodiment scans a forward 180-degree region, from cell 303 in FIG. 7, corner points that can be detected in the upward position and orientation are, for example, four points of corner points 302a to d. In contrast, corner points that can be detected in the rightward position and orientation in FIG. 7 from the cell 303 are the 10 points of corner points 302b to 302k.

In step S402, the starting position and orientation determination unit 103 evaluates position and orientation based on the number of detected corner points. That is, the starting position and orientation determination unit 103 evaluates a position and orientation in which the number of corner points detected in step S401 exceeds 5, for example, as a position and orientation that is suitable for self-position estimation.

In step S403, the starting position and orientation determination unit 103 excludes the condition-unsatisfied positions and orientations from starting position and orientation candidates. That is, in step S402, positions and orientations not evaluated as positions and orientations suitable for self-position estimation in step S402 are excluded from starting position and orientation candidates as condition-unsatisfied positions and orientations.

Next, in step S404, the starting position and orientation determination unit 103 evaluates whether or not the information acquired by the 2D LiDAR is suitable for starting position and orientation for each of the starting position and orientation candidates based on priority information and detected corner points.

That is, in step S404, the starting position and orientation determination unit 103 calculates the priority of each of the starting position and orientation candidates based on the calculation formula of evaluation value p described in the first embodiment, and determines the position and orientation having highest priority (lowest evaluation value p) as the starting position and orientation.

As described above, even with the fourth embodiment, it is possible to determine a starting position and orientation that achieves both constraints of work or passage and success of the global self-position estimation at the start of self-position estimation, such as when work is started.

### Modification 4-1

In the fourth embodiment, a method using corner points on a two-dimensional plane obtained by the 2D LiDAR that measures two-dimensional distances has been described. However, the present invention is not limited thereto, and three-dimensional corner points may be calculated from a three-dimensional point cloud obtained by the 3D LiDAR that measures three-dimensional distances.

Then, —starting position and orientation may be determined by evaluating whether or not the position and orientation are suitable for the global self-position estimation based on the three-dimensional corner points. Note that the sensor that detects the corner point is not limited to—LiDAR and may be any sensor as long as the sensor can measure—shape features.

### Modification 4-2

In step S402, although the position and orientation in which the number of corner points exceeds 5 were evaluated as the position and orientation suitable for self-position estimation, this value is an example and the present invention is not limited to this value and any value may be used.

### Fifth Embodiment

In the first embodiment, an example of determining starting position and orientation that achieves both the constraints of work or passage and success of global self-position estimation at the time of starting self-position estimation such as when the work is started has been explained. In the fifth embodiment, an example in which the movable apparatus operator can select the starting position and orientation will be explained.

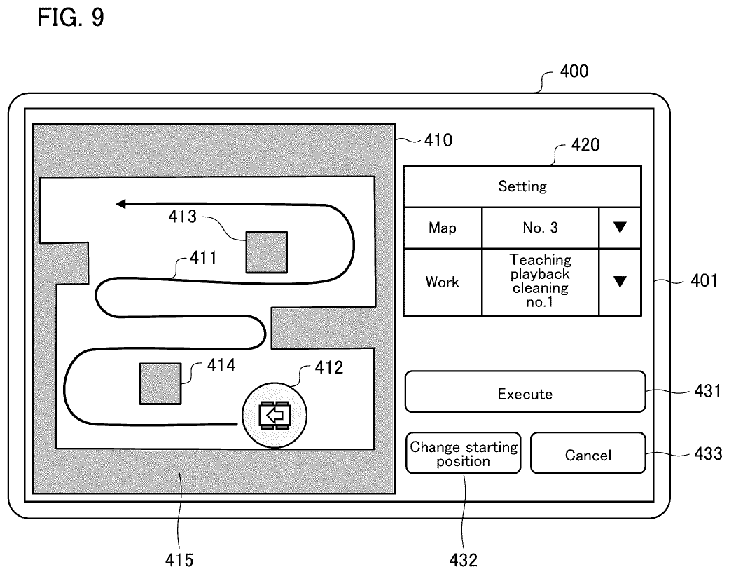

FIG. 9 is a diagram illustrating an example of the operation screen in the fifth embodiment and shows an example of the operation screen of the movable apparatus control terminal 400, which is used by the movable apparatus operator to control the movable apparatus 200, immediately after the process of step S302.

The movable apparatus control terminal 400 has a display unit 401 capable of displaying a travel path generated by the information processing apparatus 100 and an operation status of the movable apparatus 200. The display unit 401 has an input function of a touch panel system, displays information, and enables information input by a user, including the movable apparatus operator.

The content displayed on the display unit 401 include a traveling area map 410 of the movable apparatus, a setting menu 420, an execution button 431, a starting position change button 432, a cancel button 433, and the like. On the traveling area map 410, for example, the SLAM map of No. 3 selected by the movable apparatus operator on the setting menu 420 is displayed.

On the traveling area map 410, a movable apparatus marker 412 indicating starting position and orientation determined by the information processing apparatus 100 and the travel path 411 corresponding to the work content set by the movable apparatus operator on the setting menu 420 are displayed. Reference numerals 413 to 415 denote regions in which travel is impossible, which are regions outside the map range or regions such as a pillar and are regions in which the travel of the movable apparatus 200 is impossible.

Here, when the movable apparatus operator presses the execution button 431, the movable apparatus starts self-position estimation. When the movable apparatus operator presses the starting position change button 432, the starting position and orientation having the next highest starting position and orientation evaluation value is redrawn as a movable apparatus marker 412 on the travel area map 410. When the movable apparatus operator presses the cancel button 433, the information processing apparatus 100 interrupts the starting position and orientation determination processing.

As described above, according to the fifth embodiment, the movable apparatus operator can select starting position and orientation while referring to the movable apparatus control terminal 400.

### Modification 5-1

In the above example, when the starting position change button 432 is selected, although starting positions and orientations of the next ranking in starting position and orientation evaluation value are sequentially redrawn, a plurality of options may be displayed simultaneously.

That is, a plurality of starting position and orientation candidates may be sequentially or simultaneously displayed, and in this case, the starting position and orientation determination unit 103 functions as a display control unit for displaying the plurality of starting position and orientation candidates on, for example, the display unit 401 of the movable apparatus control terminal 400.

Additionally, based on the travel path 411 according to the work content set in the setting menu 420, an amount of deviation to the starting position and orientation and an expected time to reach the travel path 411 may be displayed. As a result, the movable apparatus operator can select a desired starting position and orientation from among the plurality of candidates.

### Modification 5-2

Although an example in which the movable apparatus control terminal 400 is a tablet terminal including a touch panel type liquid crystal display has been explained, the movable apparatus control terminal 400 is not limited thereto if the movable apparatus operator can confirm and input information. For example, a liquid crystal display mounted on the movable apparatus 200 may be adopted, or an input performed by an input terminal, for example, a keyboard and a mouse may be adopted.

In the above example, the traveling area map 410, the setting menu 420, the execution button 431, the starting position change button 432, the cancel button 433, and the like are displayed on the display unit 401 of the movable apparatus control terminal 400. However, any information may be displayed as long as the information is necessary or useful for the movable apparatus operator to control the movable apparatus 200, and the present invention is not limited thereto. For example, a remaining battery level of the movable apparatus 200 or an image captured by a camera may be displayed.

Note that the processing in the first embodiment to the fifth embodiment described above may be executed at the timing other than the time of work setting (at the time of mapping or localizing). Additionally, in the first embodiment to the fifth embodiment, although an example in which the starting position and orientation is determined when the work of the floor cleaning robot is set has been described, the present invention is not limited thereto. For example, when the movable apparatus operator is moving the floor cleaning robot by hand to create a map, it may be determined whether or not the current position is suitable for the starting position and orientation.

Additionally, in the first embodiment to the fifth embodiment, although an example of an autonomous cleaning robot that performs floor cleaning has been explained, the present invention can be applied to any movable apparatus that autonomously moves to perform some work, and may be applied to an autonomous movable robot for security monitoring, an autonomous movable robot for serving in a restaurant, and the like. Alternatively, the present invention may be applied to an autonomously movable drone, an automatic driving vehicle, and the like.

In the first embodiment to the fifth embodiment, in a case in which work cannot be started from the position of the starting position and orientation that has been calculated by the starting position and orientation determination unit 103, the path generation unit 204 may regenerate the path.

Additionally in the first embodiment to the fifth embodiment, although an example in which the starting position and orientation determination unit 103 calculates starting position and orientation for starting the predetermined work has been explained, the starting position and orientation determination unit 103 may calculate starting position and orientation for the autonomous movable apparatus to start self-position estimation.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing apparatus and the like through a network or various storage media. Then, a computer (or a CPU, an MPU, or the like) of the information processing apparatus and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-032940, filed on Mar. 5, 2024, which is hereby incorporated by reference herein in its entirety.

What is claimed is:

1. An information processing apparatus comprising:
at least one processor or circuit configured to function as:
a work setting information acquisition unit configured to acquire a type of work performed by a movable apparatus, information with respect to a work region, and map information for self-position estimation created in advance, and
a starting position and orientation calculation unit configured to calculate a starting position and orientation when the work is started based on the type of the work, the work region, and the map information.

2. The information processing apparatus according to claim 1, wherein the starting position and orientation calculation unit evaluates starting position and orientation candidates based on the number and distribution of feature points included in a key frame corresponding to each of the plurality of starting position and orientation candidates.

3. The information processing apparatus according to claim 1, wherein the starting position and orientation calculation unit notifies the starting position and orientation calculated when the work is started to a predetermined terminal.

4. The information processing apparatus according to claim 1, wherein the starting position and orientation calculation unit sets a priority for each of the plurality of starting position and orientation candidates.

5. The information processing apparatus according to claim 4, wherein the starting position and orientation calculation unit determines the starting position and orientation based on at least the priority.

6. The information processing apparatus according to claim 4, wherein the starting position and orientation calculation unit sets the priority based on a type of the work.

7. The information processing apparatus according to claim 4, wherein the starting position and orientation calculation unit sets the priority based on a shape, arrangement, or a movement pattern of the work region.

8. The information processing apparatus according to claim 4, wherein the starting position and orientation calculation unit sets the priority based on the starting position and orientation of the movable apparatus.

9. The information processing apparatus according to claim 1, wherein the map information is created using SLAM.

10. The information processing apparatus according to claim 1, wherein the map information includes point cloud feature information based on point cloud data acquired from a distance measuring sensor.

11. The information processing apparatus according to claim 1, wherein the at least one processor or circuit is further configured to function as,
a display control unit configured to display a starting position and orientation candidate.

12. An information processing method comprising:
acquiring a type of work performed by a movable apparatus, information with respect to a work region, and map information for self-position estimation created in advance; and
calculating a starting position and orientation when the work is started based on the type of the work, the work region, and the map information.

13. A non-transitory computer-readable storage medium configured to store a computer program comprising instructions for executing following processes:
acquiring a type of work performed by a movable apparatus, information with respect to a work region, and map information for self-position estimation created in advance; and
calculating a starting position and orientation when the work is started based on the type of the work, the work region, and the map information.
